(19) United States
(12) Patent Application Publication
(10) Pub. No.: US 2013/0205672 A1
(43) Pub. Date: Aug. 15, 2013

(54) IMPACT PLATE DOOR PROTECTOR

(71) Applicant: Peter Miller, Wauconda, IL (US)

(72) Inventor: Peter Miller, Wauconda, IL (US)

(21) Appl. No.: 13/764,072

(22) Filed: Feb. 11, 2013

Related U.S. Application Data
(60) Provisional application No. 61/597,365, filed on Feb. 10, 2012.

(51) Int. Cl. E06B 3/88

(52) U.S. Cl. CPC E06B 3/88
USPC 49/460; 49/506

(57) ABSTRACT

An impact plate that is able to lie flat when not attached to a door and bowed when attached that provides greater protection and easier installation than known approaches.

### RELATED APPLICATION

This application claim priority of provisional patent application 61/597,365, titled Impact Plate Door Protector, by Peter Miller, filed on Feb. 10, 2012, which is incorporated by reference herein.

### BACKGROUND OF TILE INVENTION

1. Field of the Invention

This invention relates generally to doors and more particularly to impact plates on traffic door.

2. Related Art

Doors, such as traffic doors, often divide the warehouse portion of a business from the sales floor and loading areas from the other areas of a building. Typically, traffic doors are found in pairs and swing both ways in order for pallet jacks and forklifts to enter and exit an area while loaded. While entering and exiting these areas, the traffic doors are hit by the pallet jacks and forklifts and swing open in response to force exerted by the device passing through the doors. The striking force usually occurs at the bottom of the doors.

In order to protect the doors, impact plates have been installed on the bottom of the doors that protect the doors from damage. The design of traditional impact plates has the space between the plate and the doors increasing from the pivoted end of the doors to the opening end. To achieve this shape, a molding process is often employed.

A problem with such an approach is that the maximum protection is provided at the opening of the doors and as an object, like a pallet, goes through the doors, it slides along the doors with less and less protection. In some circumstances, the impact plate bends and provides little, if any protection as the pallet is moved through the doors.

Therefore, there is a need for methods and systems for impact plates for doors that address these and other problems.

### SUMMARY

Systems and methods consistent with the present invention provide an approach for placing an impact plate on a door that provides greater protection by reducing the initial sticking force by moving the maximum space between the impact plate and the door to the middle of the impact plate. Further advantages to the described approach are achieved in the space required to ship the impact plate because it may be shipped in the same container as the door as it lies flat. Yet another advantage of the described approach is the impact plate may be made of the same material as the door covering.

Other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates a top view of the traffic door with brackets for holding an impact plate in accordance with and example implementation of the invention.

FIG. 2 illustrates a front view of the traffic door of FIG. 1 in accordance with an example implementation of the invention.

FIG. 3 illustrates a front view of the traffic door of FIG. 1 with multiple brackets on each side of the impact plate in accordance with an example implementation of the invention.

FIG. 4 illustrates a bracket of FIG. 1 for holding an impact plate in accordance with an example implementation of the invention.

FIG. 5 illustrates a top view and side view of an impact plate prior to installation on the traffic door of FIG. 1 in accordance with an example implementation of the invention.

FIG. 6 illustrates a top view of the traffic door with brackets and impact plate on both sides of the traffic door.

FIG. 7 depicts a flow diagram of an approach for installing an impact plate of FIG. 5 on the traffic door of FIG. 1 in accordance with an example implementation of the invention.

### DETAILED DESCRIPTION

Unlike the known approaches previously discussed, an impact plate that is able to be shipped prior to installation flat and provide added protection to traffic doors is described.

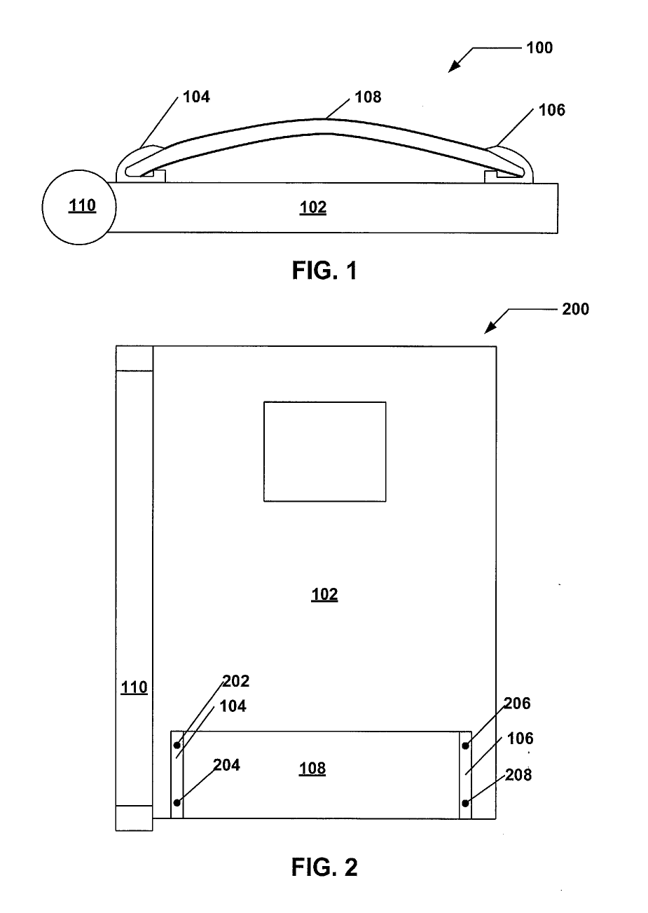

Turning first to FIG. 1, a top view 100 of traffic door 102 with brackets 104 and 106 for holding an impact plate in accordance with an example implementation of the invention is illustrated. The impact plate 108 prior to insertion is biased in a first position or flat position. Upon insertion into brackets 104 and 106, the impact plate 108 is bowed or in a second position. The bowed position is spaced further from the door in the middle and contacts the brackets 104 and 106 that are affixed to the door with the ends of the impact plate 108 nearer the sides of the door (with a door having two sides, a top and bottom). An advantage of the impact plate 108 over impact plates with their spring portions located at an end of the door furthest from the hinge, is the impact forces will typically occur in the middle of the impact plate 108 that is located in the middle of the door. Thus, the distance from the hinge 110 to the location of the force is less in the current approach than the other known approaches (the greater the length from the hinge of the striking force, the greater the force that is transferred back to the hinge).

In FIG. 2, a front view 200 of the traffic door 102 of FIG. 1 in accordance with an example implementation of the invention is illustrated. The brackets 104 and 106 are shown as single brackets on each side of the impact plate 108 (where the impact plate has two sides and a top and bottom aligned with the similar sides of the door). The brackets 104 and 106 are secured to the door via fasteners 202-208 such as rivets, bolts, screws, etc. The preferred approach is employing bolts, for example, bolting the bracket 104, impact plate 108, and traffic door 102 together. In other implementations, the bracket may have flanges on the ends to prevent the impact plate from slipping up or down and simply be held in place by the force exerted by the bowing of the impact plate 108. In yet other implementations, adhesives may be used rather than fasteners, to secure the impact plate 108 to brackets 104 and 106. In yet other implementations, the brackets may be formed in the traffic door 102 for insertion of the impact plate 108.

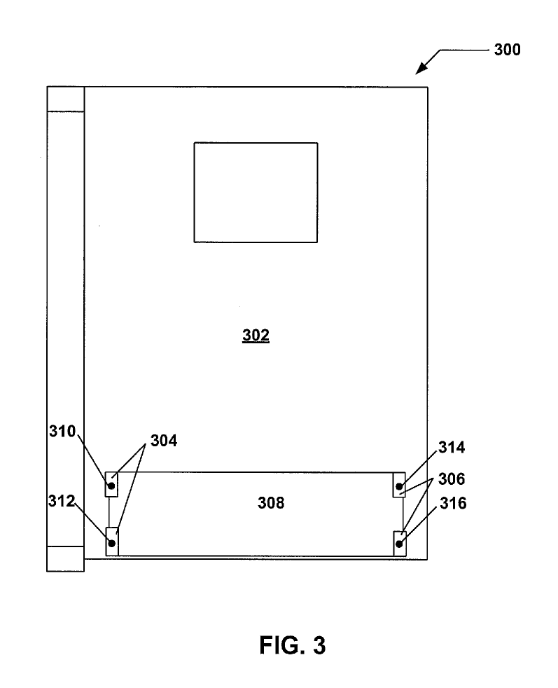

Turning to FIG. 3, a front view 300 of the traffic door 302 with multiple brackets 304-306 in accordance with an example implementation of the invention is illustrated. Two or more brackets may be used to secure the impact plate 308 in a bowed position. Typically each side of the impact plate will have at least two brackets, see 304s and 306s. The brackets are side of the impact plate will have at least two brackets, 304 and 306. The brackets are depicted in FIG. 3 as having one bolt 310-312 respectively that goes through each of the brackets 304 and 306, impact plate 308 and traffic door 302.

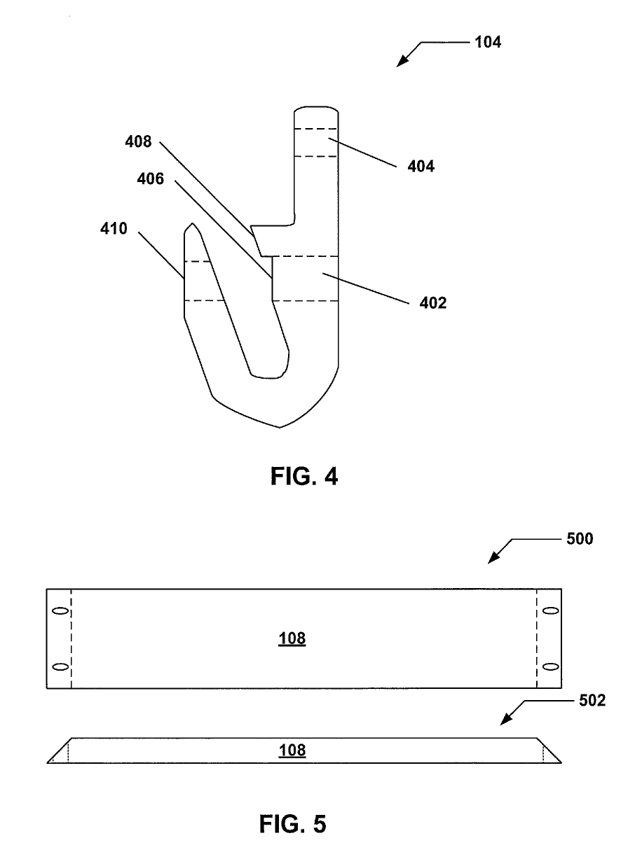

In FIG. 4, a bracket 104 of FIG. 2 for holding an impact plate 108 in accordance with an example implementation of the invention is illustrated. The bracket 104 is shown with two holes 404 and 402 that are adapted to receive fasteners. In previous figures, hole 404 and an associated fastener (bolt) were covered by impact plate 108. The bracket 104 may have a protrusion 408 that supports the impact plate 108 and is shaped to have the bowed flat surface of the impact plate 108 sit flush on the protrusion 408. A portion of the bracket is shown to define a space for the impact plate 108 and may also have a hole 410 to enable a bolt to pass through to hole 402. In other implementations the portions that define a space from the impact plate 108 may be omitted with the impact plate being fastened over the bracket.

The bracket may be formed out of extruded materials, such as plastic or metal (iron, steel, aluminum) with aluminum being the preferred material. In other implementations the bracket may be formed from cast or machined material and have more than one piece. With the current approach, a single extrusion may be used and the bracket 104 simply rotated 180 degrees for right or left facing brackets.

Turning to FIG. 5, a top view 500 and side view 502 of an impact plate prior to installation on the traffic door of FIG. 1 or FIG. 3 in accordance with an example implementation of the invention. The impact plate is biased in a flat or straight position. The ends may be tapered in order to engage the brackets with a flat surface rather than a corner. The impact plate may be made out of plastic, such as polyvinyl or any other materials that is able to be maintained in a bowed position and withstand the strike forces that traffic doors commonly encounter. Additional examples of materials that impact plates may be made from include steel and rubber. An advantage of the impact plate being biased in a flat position is the ability to be shipped in the same box as the door. Prior art impact plates have their shapes pre-formed and typically ship in containers separate from the doors that they go on. Additional shipping materials and cost are therefore avoided by the described approach.

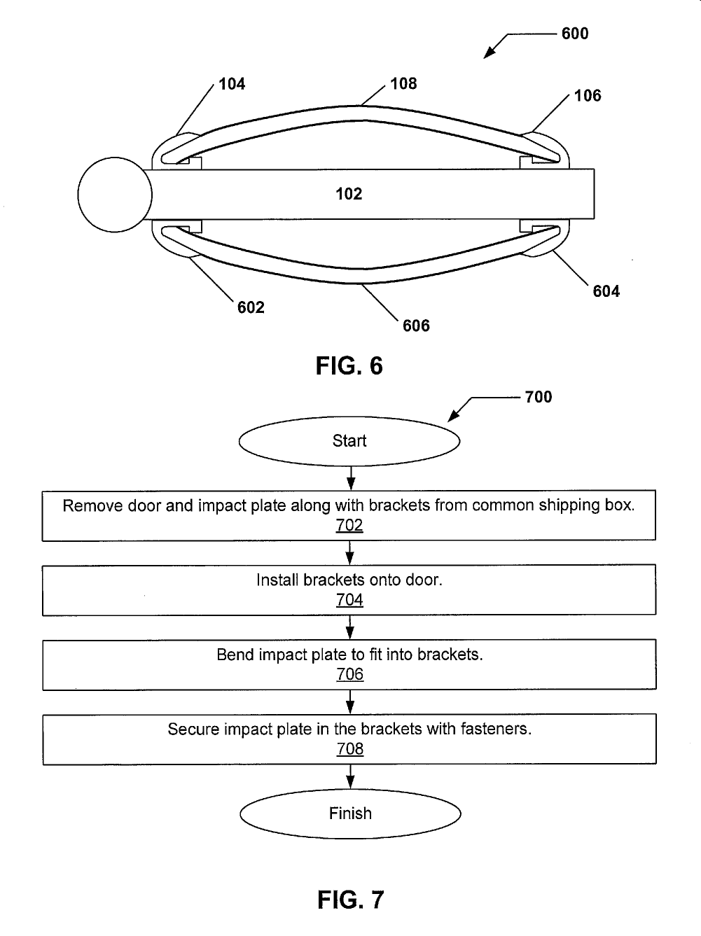

In FIG. 6, a top view of the traffic door 102 with brackets 104, 106, 602, 604 and impact plates 108 and 606 located on each side of the traffic door 102 respectively, is illustrated. Often traffic doors are enabled to swing both ways and impact plates 108 and 606 may be installed on both sides of the door. Brackets 104, 106, 602 and 604 may be installed on the door to hold the impact plates 108 and 606, respectively. The brackets may be secured to each side of the door with common bolts and nuts or similar fasteners.

Turning to FIG. 7, a flow diagram of an approach for installing an impact plate of FIG. 5 on the traffic door of FIG. 1 in accordance with an example implementation of the invention is described. The door frame will be prepared for installation of the door. The door, such as a traffic door, will be removed from a shipping box along with an impact plate and brackets in step 702. The brackets are installed on the door 704. The impact plate is bent or bowed and fitted into the brackets 706. The impact plate may then be secured in the bracket 708. In other implementations, the bracket and impact plate may be secured to the door at the same time with the same fastener.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A door protector, comprising:
a first impact plate that is in a first position; and
a door coupled to the first impact plate, where the first impact plate is held in a second position.

2. The door protector of claim 1, where the door is coupled to the first impact plate with a plurality of brackets.

3. The door protector of claim 2, where the plurality of brackets are further secured to the door with fasteners.

4. The door protector of claim 2, where the plurality of brackets are composed of aluminum.

5. The door protector of claim 1, where the second position of the impact plate is a bowed position.

6. The door protector of claim 1, where the bowed position of the impact plate results in the greatest distance between the impact plate and the door being at a mid-point of the bowed position.

7. The door protector of claim 1, further comprising a second impact plate that is in the first position prior to coupling to the door, and the second position when coupled to the door on an opposite side of the door from the first impact plate.

8. The door protector of claim 7, where the coupling of the second impact plate to the door occurs with a second plurality of brackets.

9. A method for assembling a door, comprising:
removing a first impact plate in a first position from a container;
removing a door from the container; and
coupling the first impact plate in a second position to the door.

10. The method of claim 9, where coupling further includes securing a first plurality of brackets to the door, where the first plurality of brackets restrains the first impact plate in a second position.

11. The method of claim 10, where the second position is a bowing position.

12. The method of claim 9, further including removing a second impact plate from the container, where the second impact plate is in the first position, and
coupling the second impact plate to the door on a side opposite of the first impact plate in the second position.

13. The method of claim 12, where coupling further includes securing a second plurality of brackets between the door and second impact plate.

14. A door protector, comprising:
a first impact plate that is in a first position; and
a plurality of brackets adapted for connection to a door, where the first impact plate is held in a second position by the plurality of brackets.

15. The door protector of claim 14, where the plurality of brackets are further secured to the door with fasteners.

16. The door protector of claim 14, where the plurality of brackets are composed of aluminum.

17. The door protector of claim 14, where the second position of the impact plate is a bowed position.

18. The door protector of claim 14, where the bowed position of the impact plate results in the greatest distance between the impact plate and the door being at a mid-point of the bowed position.

19. The door protector of claim 14, further comprising a second impact plate that is in the first position prior to coupling to the door, and the second position when coupled to the door on an opposite side of the door from the first impact plate.

20. The door protector of claim 19, where the coupling of the second impact plate to the door occurs with a second plurality of brackets.
